(19) United States
(12) Patent Application Publication
(10) Pub. No.: US 2008/0180938 A1
(43) Pub. Date: Jul. 31, 2008

(54) COOLING FAN CAPABLE OF SHOWING LUMINOUS FIGURES

(76) Inventors: Wen-Hao Liu, Kaohsiung (TW); Bing-Tsang Ho, Kaohsiung (TW)

Correspondence Address: G. LINK CO., LTD., 3550 BELL ROAD, MINOOKA, IL, 60447, US

(21) Appl. No.: 11/668,255

(22) Filed: Jan. 29, 2007

(51) Int. Cl. F21V 33/00; F04D 29/00

(52) U.S. Cl. 362/96; 416/5

(57) ABSTRACT

A cooling fan capable of showing luminous figures includes an impeller and a control unit. The impeller provides a hub and a plurality of blades being attached to the circumferential side of the hub. At least one of the blades has a cut-out edge at a lateral side thereof and a slot is disposed at the circumferential side corresponding to the cut-out edge. The control unit has a first circuit board and a second circuit board. The first circuit board electrically connects with the second circuit board and extending outward from the second circuit board. At least a luminous component is arranged on the first circuit board and controlled with the second circuit board. The second circuit board is placed in the hub and the first circuit board penetrates the circumferential side via the slot to fit with the cut-out edge to form the same dimension as any other blade for weight of the impeller being distributed evenly.

### BACKGROUND OF THE INVENTION

1. Field of the Invention

The present invention is related to a cooling fan capable of showing luminous figures and particularly to a fan structure, which has a circuit board with luminous members corresponding to at least one of the blades on the impeller.

2. Brief Description of the Related Art

The conventional cooling fan with luminous figures provides a soft circuit board with a plurality of luminous members mounted to the blades of the fan. Then, the luminous members are controlled with timing control circuit to brighten sequentially. Once the blades are rotated, preset figures or characters are formed due to visual temporary stay resulting from human eyes.

The cooling fan with luminous figures, which is disclosed in Taiwan utility Model Nos. M282480, M282481 and M 286561, includes a base, a coil set, a fan blade set and a control unit. The base further has a bottom with a hollow support post at the center thereof. The support post provides the first and second electrodes to electrically connect with the first and second bearings therein. The coil set is mounted to the support post with a circuit board being electrically connected to an end of the respective electrode for supplying power to the bearings. The fan blade set has a cap member with a shaft at the center of cap member. The shaft provides an inner shaft part and an outer shaft part with an insulator layer disposed between the shaft parts. The outer shaft is movably joined to the first bearing and the inner shaft is movably joined to the second bearing. The control unit is mounted to the blade set and provides the first circuit board and the second circuit board to be connected to each other electrically. The second circuit board has a plurality of luminous components controlled with the first circuit board.

While the preceding prior art is implemented, the soft circuit board with luminous components being disposed on one of the blades creates a problem of unbalance and it results in the fan blade set seriously vibrating during rotating. Under this circumference, friction between the shafts and the bearings is getting stricter and clearances between the shafts and the bearings are getting larger. Consequently, the fan is easy to become damaged and life span of the fan becomes shorter.

### SUMMARY OF THE INVENTION

Accordingly, in order to solve the preceding problems, an object of the present invention is to provide a cooling fan device capable of showing luminous figures in which the hub is provided with a slot corresponding a cut-out edge on at least one blade for a first circuit board passing through the slot to fit with the cut-out edge so as to form the same dimension as any other blades such that weight of the impeller is distributed evenly.

Another object of the invention is to provide a cooling fan device capable of showing luminous figures in which the first circuit board has a circular outer end for avoiding turbulence.

In order to achieve the preceding object, a cooling fan capable of showing luminous figures according to the present invention includes an impeller and a control unit. The impeller provides a hub and a plurality of blades being attached to the circumferential side of the hub. At least one of the blades has a cut-out edge at a lateral side thereof and a slot is disposed at the circumferential side corresponding to the cut-out edge. The control unit has a first circuit board and a second circuit board. The first circuit board electrically connects with the second circuit board and extending outward from the second circuit board. At least a luminous member is arranged on the first circuit board and controlled with the second circuit board. The second circuit board is placed in the hub and the first circuit board penetrates the circumferential side via the slot to fit with the cut-out edge to form the same dimension as any other blade for weight of the impeller being distributed evenly.

### BRIEF DESCRIPTION OF THE DRAWINGS

The detail structure, the applied principle, the function and the effectiveness of the present invention can be more fully understood with reference to the following description and accompanying drawings, in which:

FIG. 1 is an exploded perspective view of a cooling fan capable of showing luminous figures according to the present invention;

FIG. 2 is a side view of the impeller of the cooling fan shown in FIG. 1;

FIG. 3(a) is a side view illustrating comparison between a blade with a cut-out edge and a fan blade without a cut-out edge;

FIG. 3(b) is a top view illustrating comparison between a fan blade with a cut-out edge and a fan blade without a cut-out edge;

FIG. 4 is a perspective view of the control unit of the present invention;

FIG. 5(a) is a perspective view of the impeller of the present invention illustrating the control unit;

FIG. 5(b) is a plan view of the impeller of the present invention illustrating the control unit;

FIG. 6 is a perspective view similar to FIG. 5a illustrating the enlarged projection 114 at the axial shaft 13; and

FIG. 7(a) is a perspective view similar to FIG. 5a illustrating another type cut-out edge of the blade; and

FIG. 7(b) is a plan view similar to FIG. 5b illustrating another type cut-out edge of the blade.

### DETAILED DESCRIPTION OF THE INVENTION

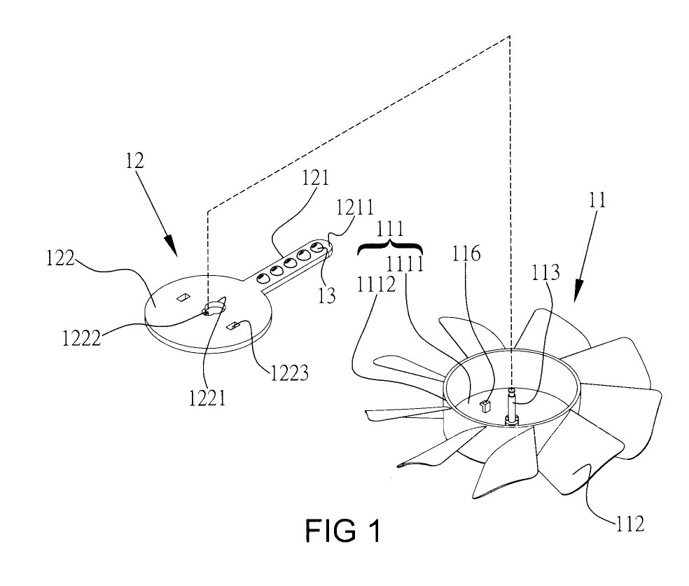

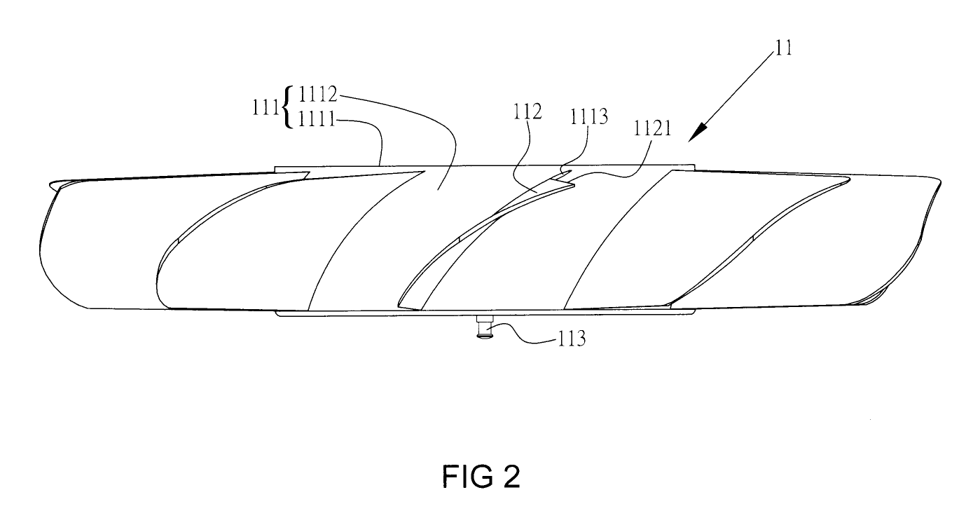

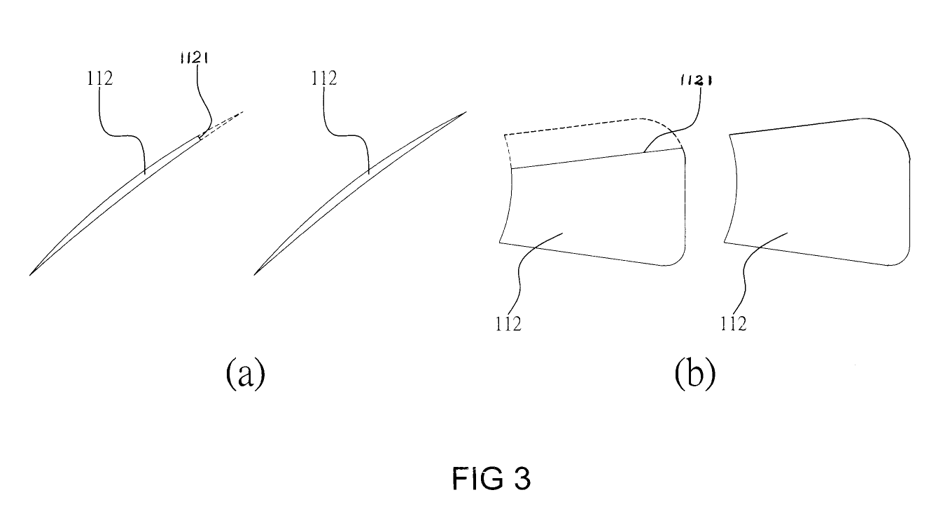

Referring to FIGS. 1, 2, 3(a) and 3(b), a preferred embodiment of a cooling fan capable of showing luminous figures according to the present invention includes an impeller 11 and a control unit 12. The impeller 11 further includes a hub 111 and a plurality of blades 112. The hub 111 has a top side 1111 and a circumferential side 1112. The blades 112 are attached to the circumferential side 1112 of the hub 111 and one of the blades 112 has a cut-out edge 1121 at a lateral side thereof. The circumferential side 1112 provides a slot 1113 corresponding to the cut-out edge 1121. It can be seen in FIGS. 3(a) and 3(b) that difference between the blade 112 with the cut-out edge 1121 and any other blades 112 without the cut-off edge 1121 is illustrated and the cut-out portion of the blade 112 with cut-out edge 1121 is shown with dash lines.

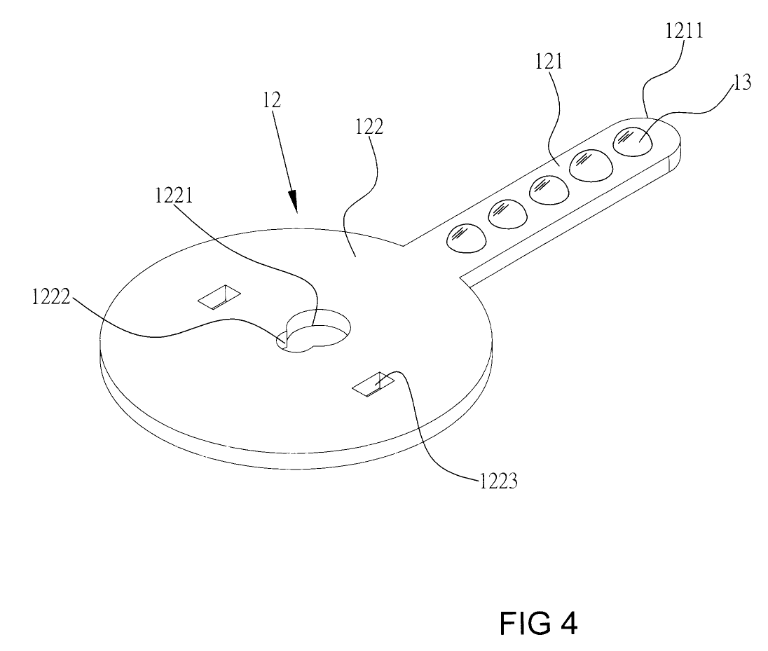

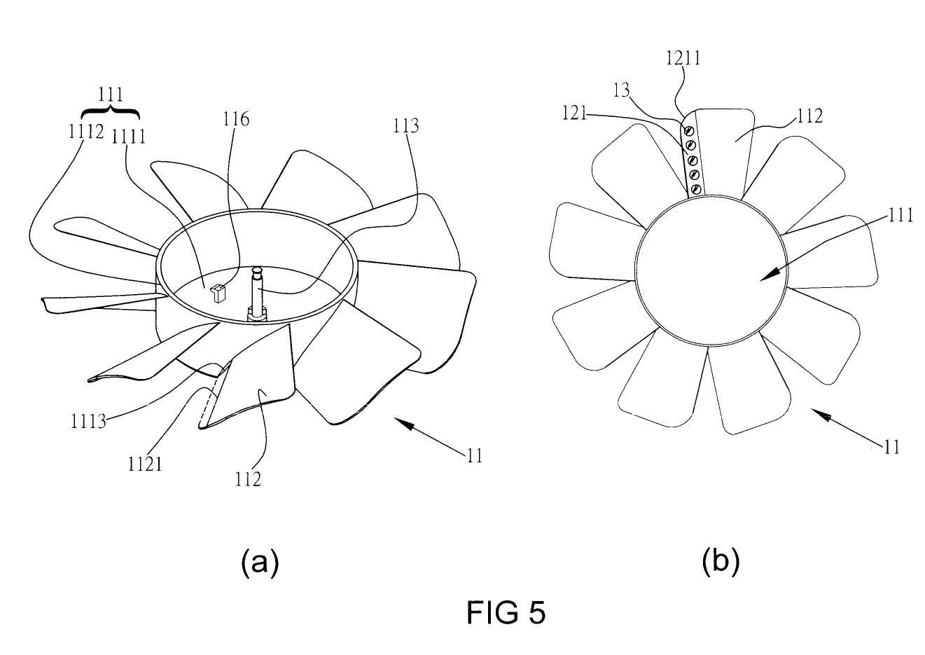

Referring to FIGS. 4, 5(a) and 5(b) in company with FIG. 1, the control unit 12 has a first circuit board 121 and a second circuit board 122. The first circuit board 121 is electrically connected to the second circuit board 122 and extends outward from the second circuit board 122. At least a luminous component 13 is provided on the first circuit board 121 and controlled with the second circuit board 122. The second circuit board 122 is disposed in the hub 111 and the first circuit board 121 passes outward the hub 111 via the slot 1113 to engage with the cut-out edge 1211 to make up the cut-out part. Hence, the blade 121 with cut-out edge 1121 being joined to the first circuit board 122 constitutes the same dimension as other blades without the cut-out edge 1211.

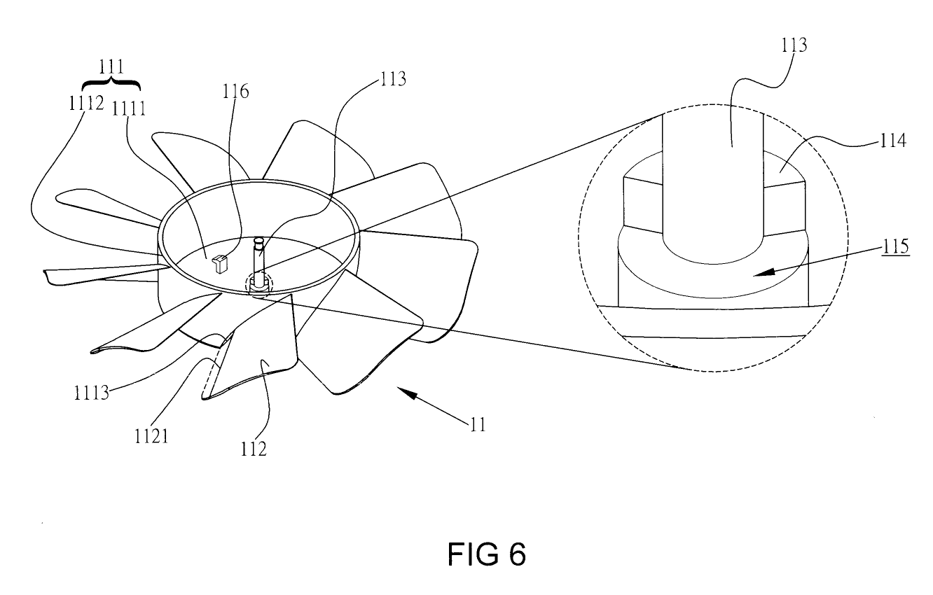

Referring to FIG. 6 in company with FIGS. 1, 5(a) and 5(b) again, the impeller 11 has an axial shaft 113 at the top side 1111 thereof and a cylindrical projection 114 is formed on the outer side of the shaft 113 at the joint of the top side 1111 and the shaft 113. The cylindrical projection 114 has a circular indentation 115 at the outer end thereof.

Referring to FIGS. 1, 2 and 4 again, the second circuit board 122 provides a first opening 1221 and a second opening 1222 and the two openings interfere with each other. The first opening 1221 is larger than the second opening 1222 such that the first opening 1221 temporarily fits with the shaft 113 to allow the first circuit board 121 with the second circuit board 122 being capable of entering the hub 111 in a way of slightly tilting an angle before the second circuit board 122 with the first circuit board 121 is placed in the hub 111. The first circuit board 121 is capable of inserting through the slot 1113 smoothly and extends outward the hub 111 once the second circuit board 122 is horizontally disposed in the hub 111. As a result, a lateral side of the second circuit board 112 touches the top side 1111 and the second opening 1222 fits with the shaft 113.

The top side 1111 further provides an L shaped fixing member 116 and the second circuit board 122 provides at least a fixing hole 1223 corresponding to the fixing member 116 such that the fixing member 116 is capable of engaging with the fixing hole 1223 for the second circuit board 122 being attached to hub 111 firmly and driven with the hub 111.

Further, the free end of the first circuit board 121 is a circular end 1211 and the blade 112 with the cut-out edge 1121 associated with the first circuit board 121 has the same weight as any other blade 112 without the cut-out edge 1121 in addition to the same dimension. In this way, the weight of the impeller 11 is distributed evenly and problem of frictional wear between the shaft 113 and bearings (not shown) can be avoided. Besides, the circular free end 1211 of the first circuit board 121 is capable of resisting turbulence during the impeller 11 rotating to induce fluid flow.

The control circuit, which is disclosed in Taiwan Utility Model Nos. M282480, M282481 and M286561 respectively, can be employed in the second circuit board 122 to control the luminous component 13 on the first circuit board 122 for showing the desired figures or characters.

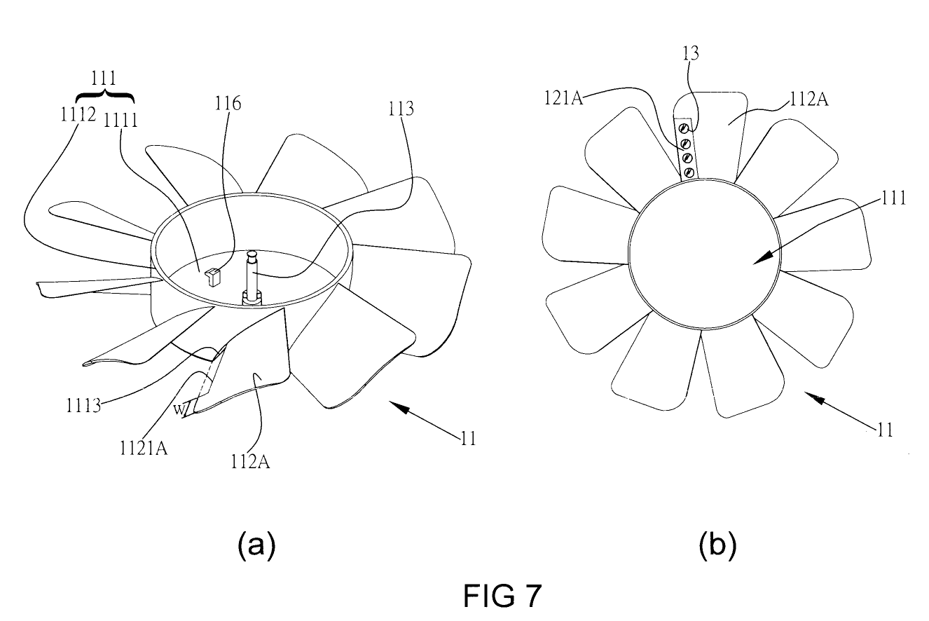

Further, referring to FIGS. 7(a) and 7(b), another embodiment of the present invention is illustrated. The difference of the present embodiment from the preceding embodiment is in that a cut-out edge 1121A of the blade 112A is shorter than the radial length of the blade 112A, that is, the elongated side of the cut-out edge 112A does not extend to the outer end of the blade 112A such that a length difference W is formed between the outer end of the blade 112A and the cut-out edge 112A. The first circuit board 121A provides a dimension coinciding with the cut-out edge 112A such that the blade 112A associated with the first circuit board 121A has an integral dimension identical with any other blade.

It is noted that the first circuit board 121 can be made with the second circuit board 122 integrally.

While the invention has been described with referencing to preferred embodiments thereof, it is to be understood that modifications or variations may be easily made without departing from the spirit of this invention, which is defined by the appended claims.

What is claimed is:

1. A cooling fan capable of showing luminous figures comprising:
an impeller providing a hub with a top and a circumferential side, the top being attached to an axial shaft, a plurality of blades being attached to the circumferential side, at least one of the blades having a cut-out edge at a lateral side thereof and a slot being disposed at the circumferential side corresponding to the cut-out edge; and
a control unit providing a first circuit board and a second circuit board, the first circuit board electrically connecting with the second circuit board and extending outward from the second circuit board, at least a luminous component being arranged on the first circuit board and controlled with the second circuit board;
wherein the second circuit board is placed in the hub and the first circuit board penetrates the circumferential side via the slot to fit with the cut-out edge.

2. The cooling fan capable of showing luminous figures as defined in claim 1, wherein the second circuit board has a first opening and a second opening with the second opening being disposed next to the first opening in a way of interfering with the first opening and the first opening being larger than the second opening.

3. The cooling fan capable of showing luminous figures as defined in claim 1, wherein the top has an inner side with a fixing member corresponding to the second circuit board.

4. The cooling fan capable of showing luminous figures as defined in claim 1, wherein the cut-out edge is shorter than the radial length of the blade.

5. The cooling fan capable of showing luminous figures as defined in claim 1, wherein the first circuit board has a circular outer end.

6. The cooling fan capable of showing luminous figures as defined in claim 5, wherein the circular outer end coincides with the outer end of the blade.

7. The cooling fan capable of showing luminous figures as defined in claim 5, wherein the circular outer end is a free end.

8. The cooling fan capable of showing luminous figures as defined in claim 4, wherein the first circuit board provides a dimension coincides with the cut-out edge.

9. The cooling fan capable of showing luminous figures as defined in claim 1, wherein a joint of the top and the axial shaft has a cylindrical projection with a circular indentation.
